(19) United States
(12) Patent Application Publication
(10) Pub. No.: US 2014/0340556 A1
(43) Pub. Date: Nov. 20, 2014

(54) INFORMATION PROCESSING APPARATUS

(71) Applicant: NEC CASIO MOBILE COMMUNICATIONS, LTD., Kanagawa (JP)

(72) Inventor: Kenta Fukuoka, Kanagawa (JP)

(73) Assignee: NEC CASIO MOBILE COMMUNICATIONS, LTD., Kanagawa (JP)

(21) Appl. No.: 14/360,561

(22) PCT Filed: Dec. 17, 2012
(86) PCT No.: PCT/JP2012/082605

§ 371 Date: May 23, 2014

(30) Foreign Application Priority Data
Dec. 16, 2011 (JP) 2011-275609

(51) Int. Cl. H04N 5/232

(52) U.S. Cl. CPC H04N 5/23216; H04N 5/23293
USPC 348/333.01

(57) ABSTRACT

A display unit (120) displays a captured image taken by an imaging unit (110). A detection unit (130) detects an operation performed on a screen of the display unit (120). When the operation detected by the detection unit (130) is a predetermined operation, a control unit (140) causes the display unit (120) to continue displaying a captured image taken at a predetermined timing, selected from among the captured images.

### TECHNICAL FIELD

The present invention relates to an information processing apparatus, information processing method, and program, for processing information.

### BACKGROUND ART

Recently, in information processing apparatuses including a display having touch-panel function, typified by mobile terminals, as the user touches the display with a finger or the like, the information displayed at the position where a touch has been detected on the display is selected (extracted) so that the operation corresponding to the selected information is carried out (e.g., see Patent Document 1).

### RELATED ART DOCUMENTS

### Patent Documents

Patent Document 1: JP2011-217275A

### SUMMARY OF THE INVENTION

### Problems to be Solved by the Invention

In the above-described information processing apparatus, if the image being displayed on the display is a still image, it is possible to definitely select the information because the position of the information, that a user desires to select, is fixed.

However, in an information processing apparatus including a camera or other image function, when the taken image is displayed as a preview image on the display and a desired piece of information is selected from the image being displayed, there are cases when it is difficult to make a selection.

For example, when the subject is moving, or when the user holding the information processing apparatus is moving, or when an object that disturbs image is moving between the information processing apparatus and the subject, and other cases, the position of the information being displayed on the display will not be fixed, posing the problem that selection of the information becomes difficult.

The object of the present invention is to provide an information processing apparatus, information processing method and program for solving the problem described above.

### Means for Solving the Problems

An information processing apparatus of the present invention includes:

an imaging unit;

a display unit that displays captured images taken by the imaging unit;

a detection unit that detects an operation performed on a screen of the display unit;

a control unit that continues displaying a captured image taken at a predetermined timing, of the captured images, on the display unit when the operation detected by the detection unit is a predetermined operation.

An information processing method of the present invention is used to process information displayed on a display unit, comprising the steps of:

imaging;

displaying captured images taken by the imaging, on the display unit;

detecting an operation performed on a screen of the display unit;

determining whether or not the detected operation is a predetermined operation; and

continuing display of a captured image taken at a predetermined timing, of the captured images, on the display unit when the detected operation is a predetermined operation.

A program of the present invention is used to cause an apparatus including a display unit to execute a process comprising:

a step of imaging;

a step of displaying captured images taken by the imaging, on the display unit;

a step of detecting an operation performed on a screen of the display unit;

a step of determining whether or not the detected operation is a predetermined operation; and

a step of continuing display of a captured image taken at a predetermined timing, of the captured images, on the display unit when the detected operation is a predetermined operation.

### Effect of the Invention

As described heretofore, in the present invention, it is possible to easily select a desired piece of information from the image being displayed.

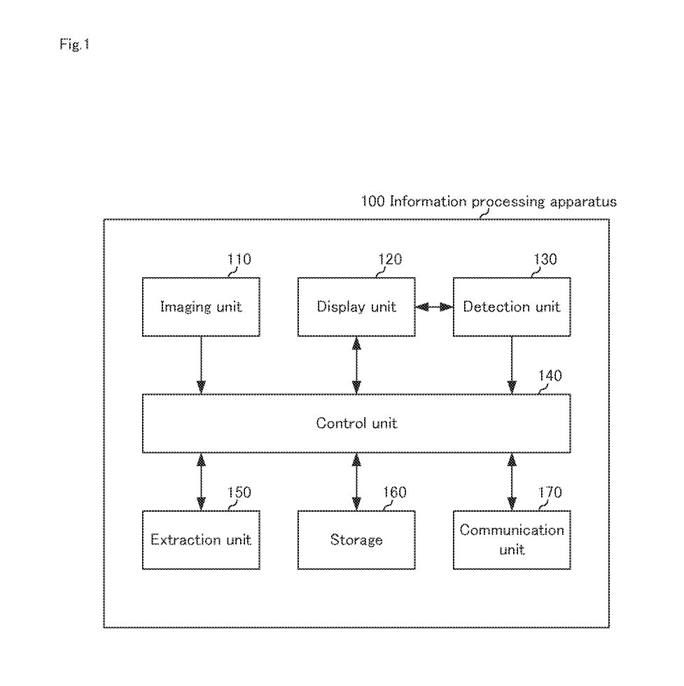

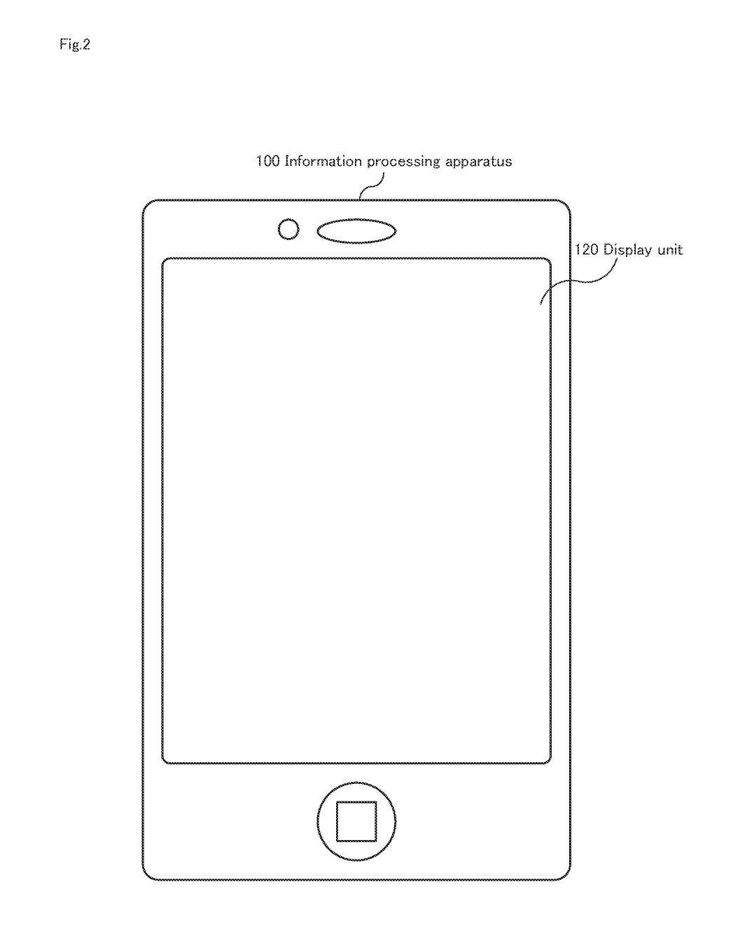

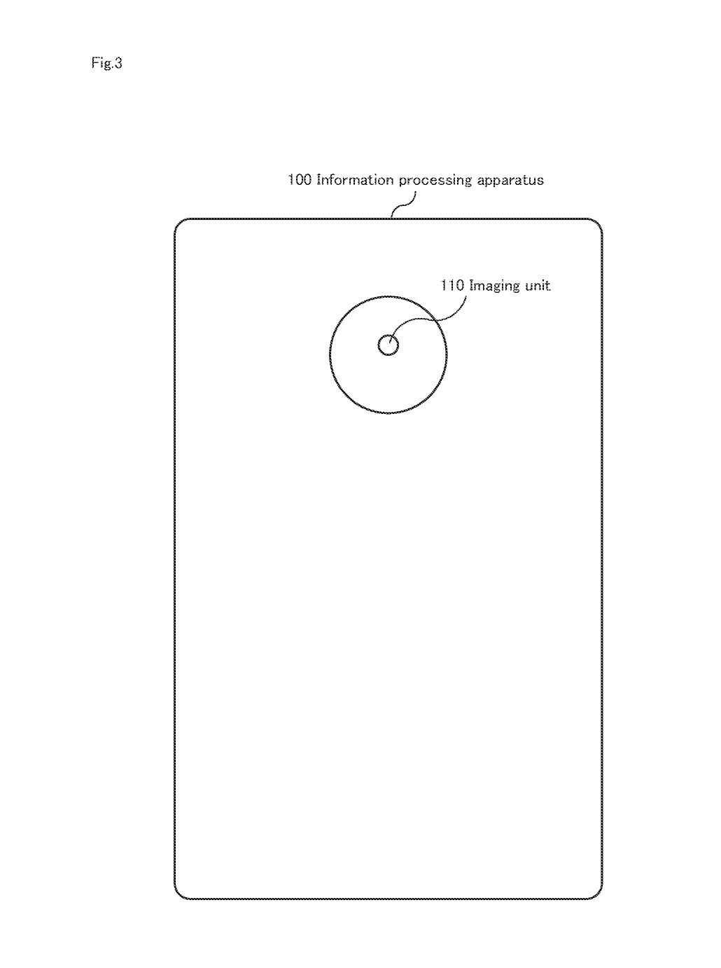

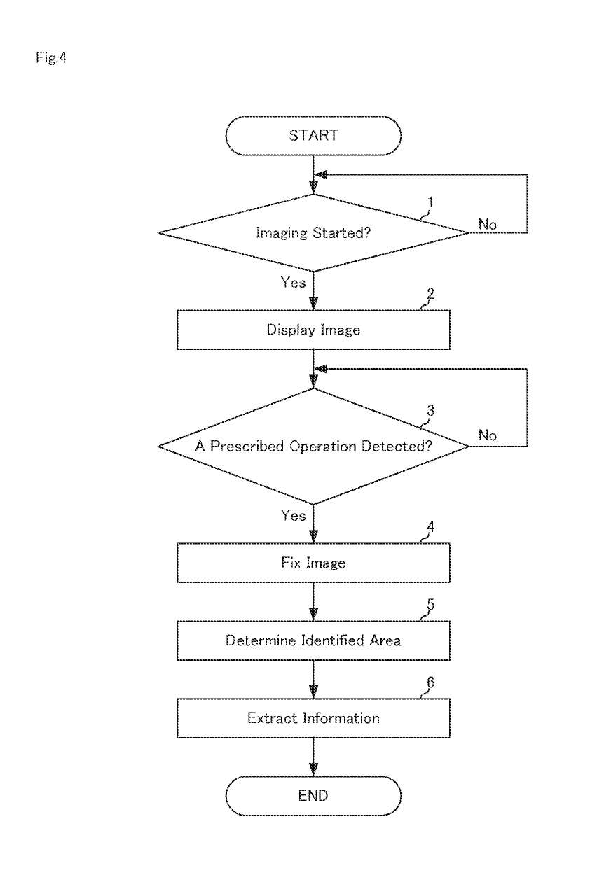

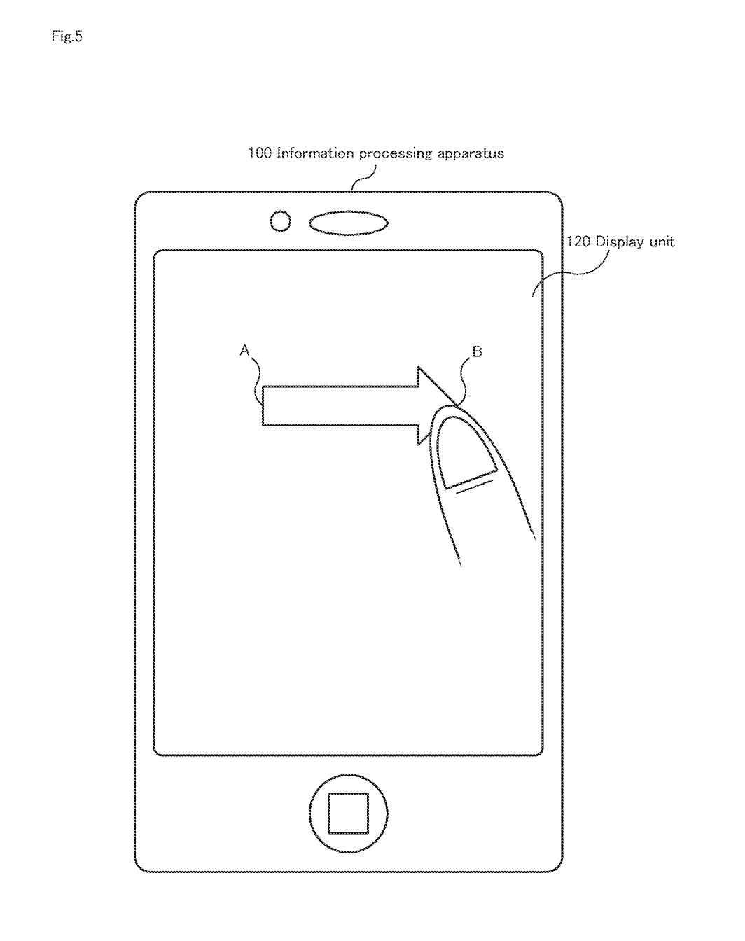

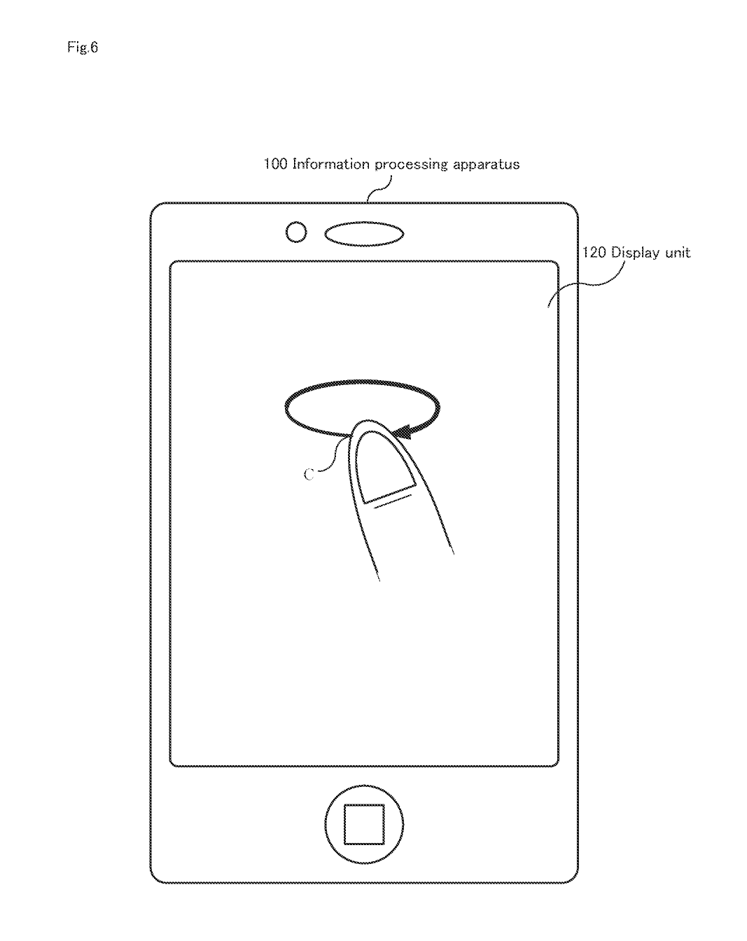

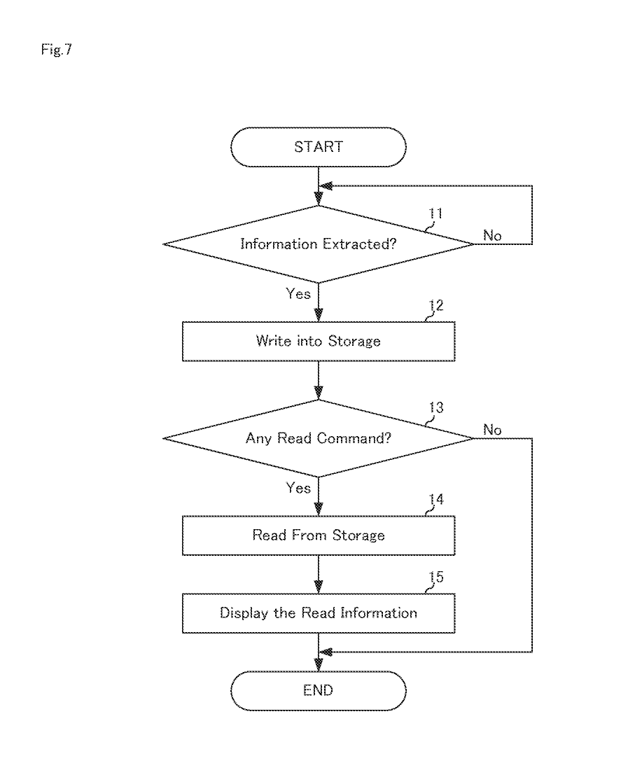

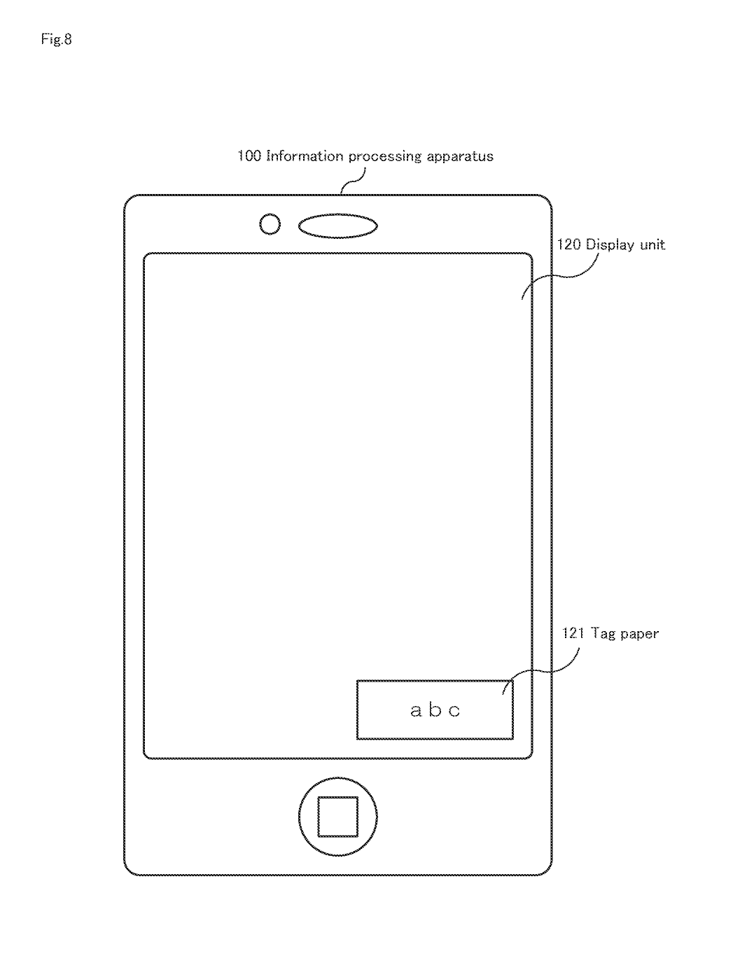

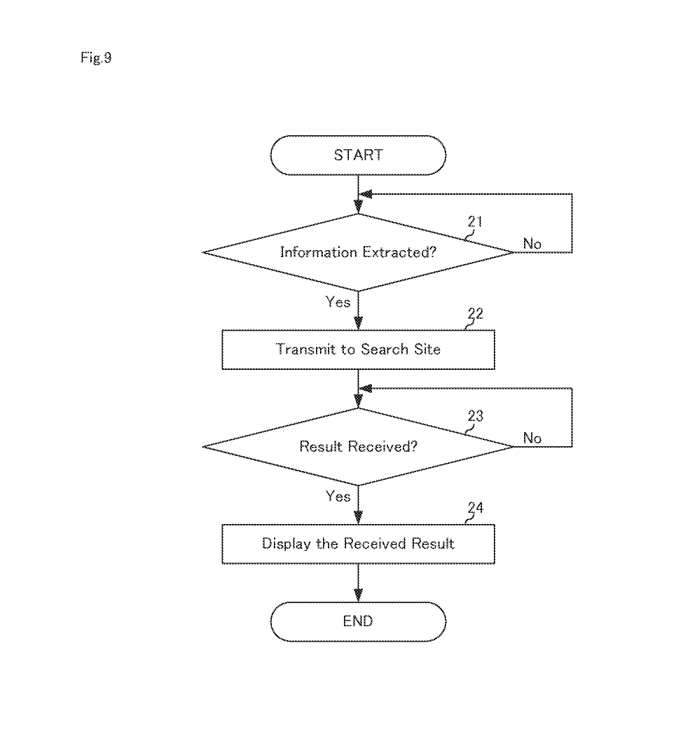

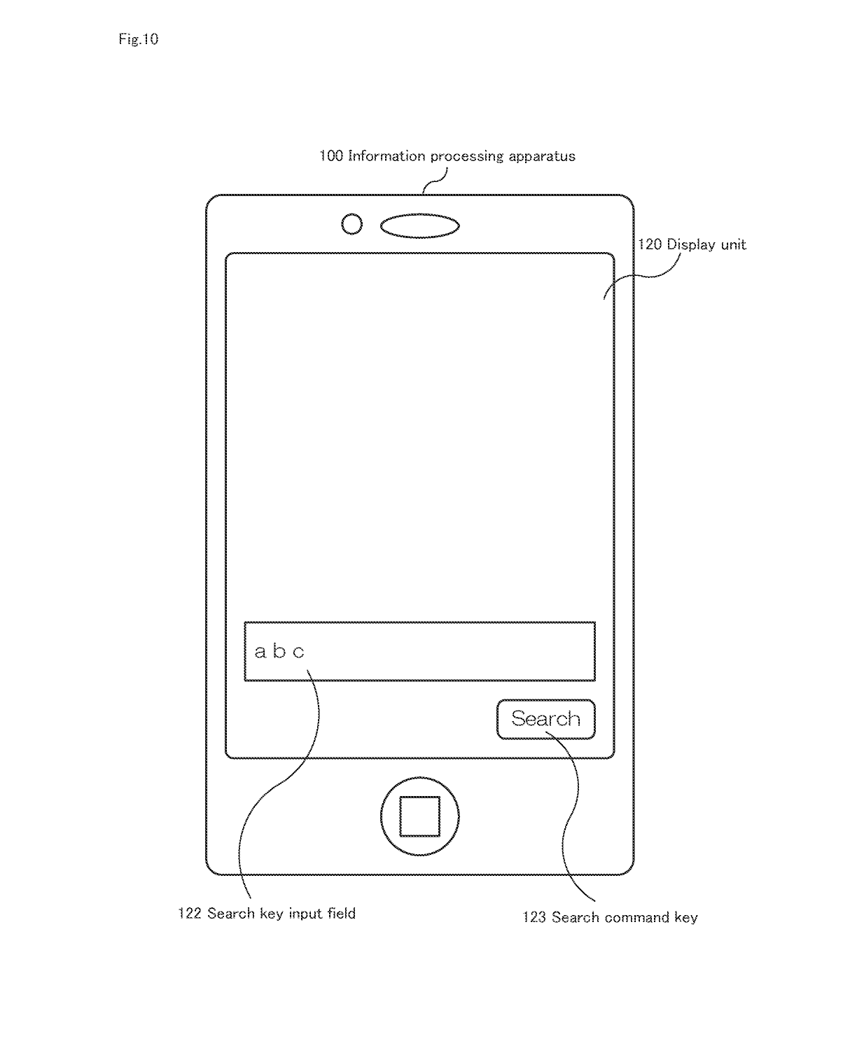

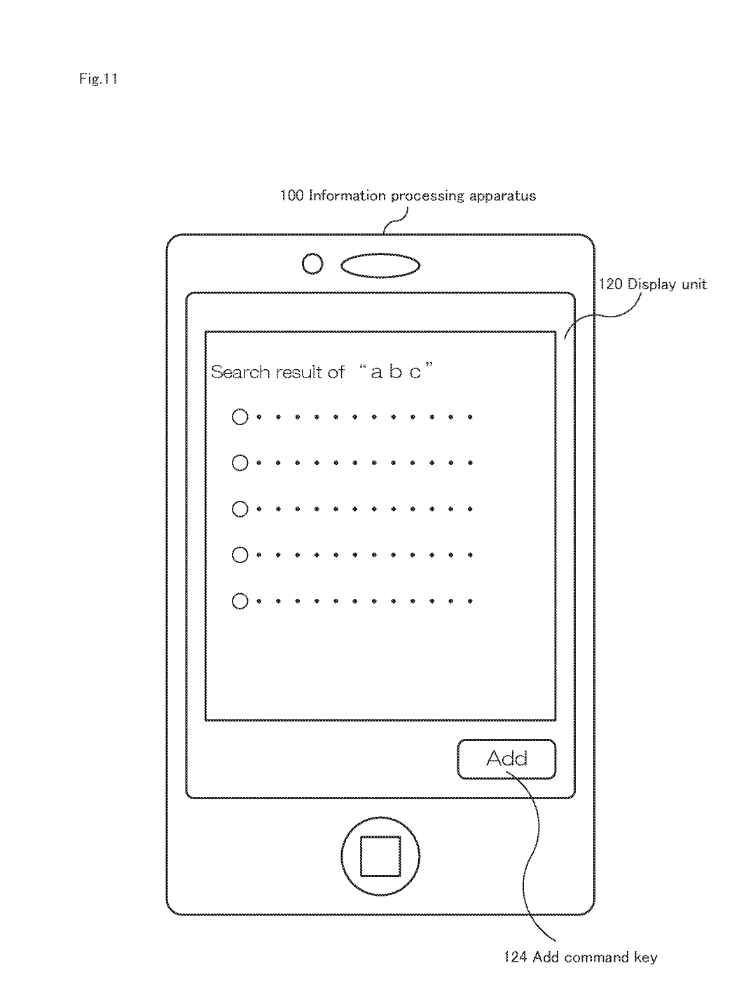

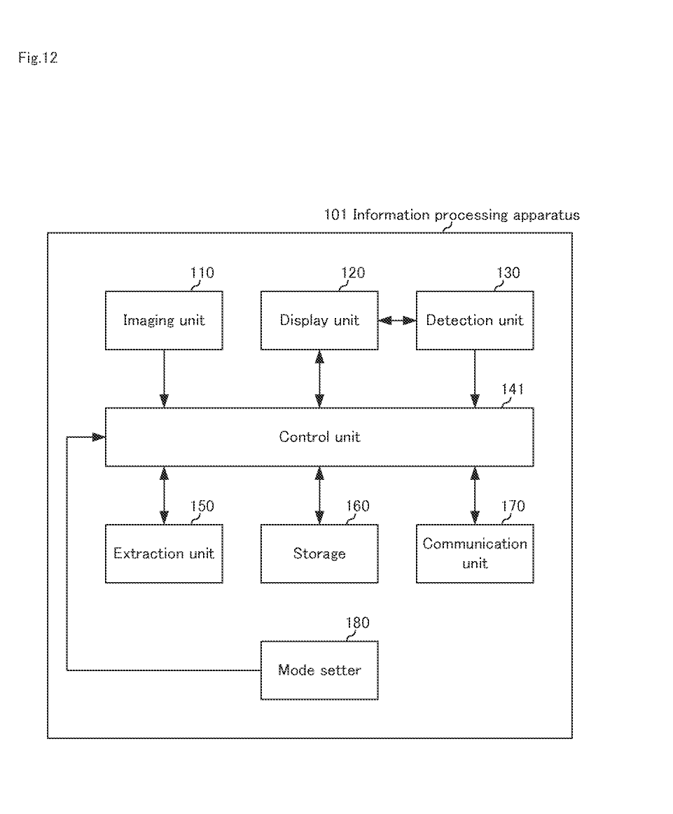

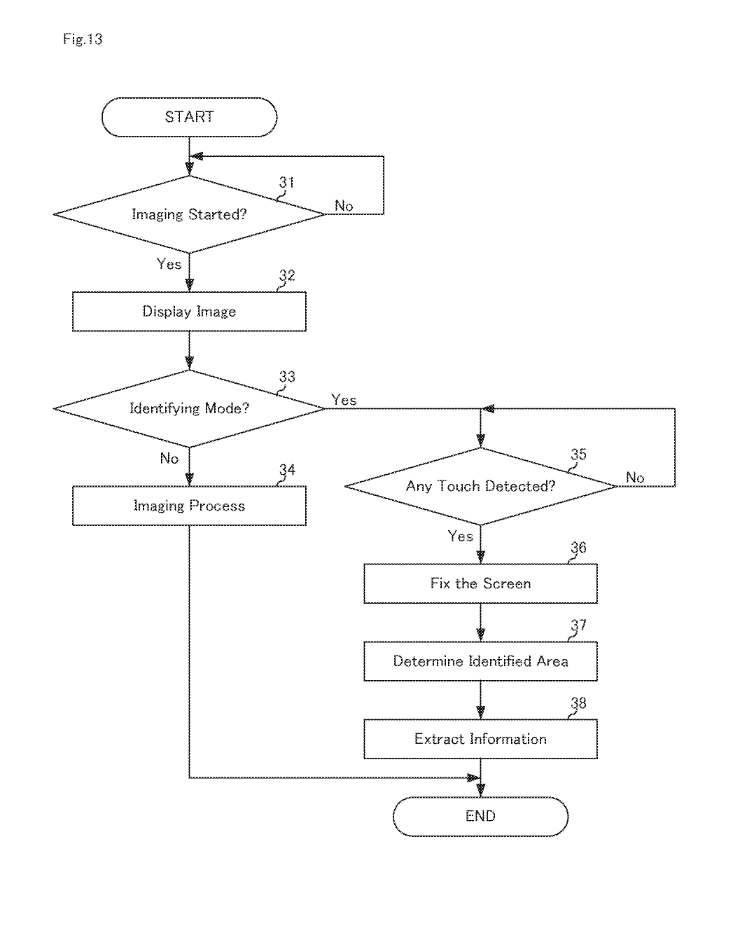

### BRIEF DESCRIPTION OF THE DRAWINGS

[FIG. 1] A diagram showing one exemplary embodiment of an information processing apparatus of the present invention.

[FIG. 2] An example of an external view of the information processing apparatus shown in FIG. 1, viewed from the screen side of the display unit.

[FIG. 3] An example of an external view of the information processing apparatus shown in FIG. 1, viewed from the side on which an imaging unit is disposed.

[FIG. 4] A flow chart for explaining the process of extracting information from among the information processing methods in the information processing apparatus shown in FIG. 1.

[FIG. 5] A diagram showing one example of a touch operation performed on the screen of the display unit, detected by the detection unit shown in FIG. 1.

[FIG. 6] A diagram showing another example of a touch operation performed on the screen of the display unit, detected by the detection unit shown in FIG. 1.

[FIG. 7] A flow chart for explaining the process, in the information processing method in the information processing apparatus shown in FIG. 1, of storing extracted information and reading and displaying the information when a command to read the stored information is given.

[FIG. 8] A diagram showing one example of a screen on which information is displayed on the display unit shown in FIG. 1.

[FIG. 9] A flow chart for explaining the process, in the information processing method, in the information processing apparatus shown in FIG. 1, of searching for related information relating to the extracted information, by using the extracted information as a search key.

[FIG. 10] A diagram showing one screen example in which extracted information and a command key for sending the information to a search site are displayed in the display unit shown in FIG. 1.

[FIG. 11] A diagram showing one screen example in which the search result received by the communication unit shown in FIG. 1 is displayed in the display unit.

[FIG. 12] A diagram showing another exemplary embodiment of an information processing apparatus of the present invention.

[FIG. 13] A flow chart for explaining the process of extracting information, in the information processing method in the information processing apparatus shown in FIG. 12.

### MODE FOR CARRYING OUT THE INVENTION

Next, exemplary embodiments of the present invention will be described with reference to the drawings.

FIG. 1 is a diagram showing one exemplary embodiment of an information processing apparatus of the present invention.

As shown in FIG. 1, information processing apparatus 100 in this configuration includes imaging unit 110, display unit 120, detection unit 130, control unit 140, extraction unit 150, storage 160, and communication unit 170.

Imaging unit 110 shoots subjects, and information processing apparatus 100 takes in the shot image as a captured image. Imaging unit 110 may be a camera, for example.

Display unit 120 is a display for displaying the captured image taken by imaging unit 110. Display unit 120 displays this captured image as a preview pane for performing an imaging process as practiced by the camera function equipped in a typical mobile terminal.

Detection unit 130 detects an operation on the screen of display unit 120. For example, detection unit 130 may be a contact sensor or proximity sensor. When detection unit 130 is a contact sensor or proximity sensor, detection unit 130 detects the touch or approach of an object such as user's finger or pen that touches to the screen of display unit 120. Detection unit 130 further detects the position at which an operation is performed on the screen.

Control unit 140 determines whether or not the operation detected by detection unit 130 is a predetermined operation. Herein, control unit 140 determines an operation detected by detection unit 130 on the screen as the prescribed operation when the moving distance of the operation exceeds a predetermined threshold.

Further, when having determined that the operation detected by detection unit 130 is a predetermined operation, control unit 140 keeps on displaying a captured image, of the captured images, that was taken at a predetermined timing, on display unit 120. That is, usually, the preview pane displayed on display unit 120 successively displays a plurality of captured images taken by imaging unit 110 in a time-sequentially manner. However, control unit 140 causes display unit 120 to continue displaying one of the captured images at a certain timing.

Herein, in order to enable display unit 120 to display past captured images, control unit 140 temporarily stores the captured images taken by imaging unit 110 into a buffer (memory). Then, when having determined that the operation detected by detection unit 130 is a predetermined operation, control unit 140 may read the captured image taken by imaging unit 110 at a point of time when the predetermined operation started, from the buffer and continue displaying the read, captured image on display unit 120. Alternatively, when having determined that the operation detected by detection unit 130 is a predetermined operation, control unit 140 may read the captured image taken by imaging unit 110 at a time when the determination was made, from the buffer and continue displaying the read, captured image on display unit 120. In this way, control unit 140 causes display unit 120 to keep on displaying (continuously display) the captured image at a certain time, whereby the user viewing display unit 120 can see the image being displayed on the display unit 120 as a still (fixed) image.

Further, control unit 140 may be adapted to analyze the type of information (image information, text information, etc.) that has been extracted by extraction unit 150.

Control unit 140, using the information extracted by extraction unit 150 as a search key, searches for information (related information) relating to that information. At this point, control unit 140 may search for related information from the information stored inside information processing apparatus 100 or may cause a communication device, that can communicate with information processing apparatus 100, to search for information that relates to the extended information and acquire the search result. The search method may be text search if the information extracted by extraction unit 150 is textual information. If the information extracted by extraction unit 150 is image information, an image search may be used. Herein, the search method is not particularly limited. Further, information processing apparatus 100 may include a search engine or other search functionality, or may perform a search by simply transmitting a search key to a search site to receive the result.

Further, control unit 140 may write information extracted by extraction unit 150 into storage 160. Also, control unit 140 may read information written in storage 160 and display the information on display unit 120 when a predetermined input is provided from the outside.

Extraction unit 150 extracts from the image being displayed by display unit 120, the information displayed in an identified area corresponding to the position at which detection unit 130 has detected a predetermined operation on the screen. This extracted information may be image information, textual information as mentioned above, or code information such as a barcode and 2D code. The method of determining the identified area will be described later.

Storage 160 is a memory that allows information to be written therein and read therefrom. Here, storage 160 may be a memory installed in information processing apparatus 100 or a storage medium removable from information processing apparatus 100.

Communication unit 170 has interface functionality for communication with external communication devices. For example, communication unit 170 may use the same configuration as is used for telephone calls and packet communication in typical mobile communication terminals.

FIG. 2 is an example of an external view of information processing apparatus 100 shown in FIG. 1, viewed from the screen side of display unit 120.

When information processing apparatus 100 shown in FIG. 1 is viewed from the screen side (front side) of display unit 120, display unit 120 is disposed on the front side of information processing apparatus 100, as shown in FIG. 2.

FIG. 3 is an example of an external view of information processing apparatus 100 shown in FIG. 1, viewed from the side on which imaging unit 110 is disposed.

When information processing apparatus 100 shown in FIG. 1 is viewed from the side (rear side) on which imaging unit 110 is disposed, imaging unit 110 is disposed on the rear side of information processing apparatus 100, as shown in FIG. 3.

Here, the appearance of information processing apparatus 100 shown in FIGS. 2 and 3 is an example where information processing apparatus 100 is a smartphone. When information processing apparatus 100 is a digital camera or any other device, display unit 120 and imaging unit 110 are arranged at positions depending on the type of device.

Now, the information processing method in information processing apparatus 100 shown in FIG. 1 will be described. To begin with, from among the information processing methods in information processing apparatus 100 shown in FIG. 1, the process up to extraction of information will be described.

Description herein will be described by giving an example where detection unit 130 is a contact sensor. That is, description will be made by giving an example where the operation to be detected by detection unit 130 is a “touch operation” in which an object touches the screen of display unit 120.

FIG. 4 is a flow chart for explaining the process up to the extraction of information, in the information processing method in information processing apparatus 100 shown in FIG. 1.

First, control unit 140 determines whether or not a command to start imaging is given, at Step 1. The method of this determination may be that, for example, based on recognition that the icon representing the imaging function has been selected from the menu displayed on display unit 120 by the user, control unit 140 determines that a command to start imaging has been given.

After a command to start imaging is given, imaging unit 110 is activated so that the captured image taken by imaging unit 110 is displayed on display unit 120 at Step 2.

Then, detection unit 130 starts detection of a touching operation in which an object touches the screen of display unit 120.

Subsequently, at Step 3 control unit 140 determines whether or not the touch detected by detection unit 130 is a predetermined contact. This may be realized by, for example, control unit 140 determining whether or not the moving distance (the distance of movement) that was moved from position at which the touching operation on the screen of display unit 120 and that was detected by detection unit 130 (the start position of the touch) exceeds a previously set threshold (distance), and the touch detected by detection unit 130 is determined to be the predetermined contact when the movement exceeds the threshold.

When control unit 140 determined that the touch detected by detection unit 130 is a predetermined contact, control unit 140 keeps on displaying the captured image, selected from the captured images, that has been taken at a predetermined timing, on display unit 120. At this time, as the user sees display unit 120, the image being displayed on display unit 120 looks fixed like a still image. The predetermined timing herein may be the time when detection unit 130 starts detection of the touch, or the time when the control unit determines that the moving distance, from the location that the touching object moves, exceeds the threshold. If the predetermined timing is assumed to be the time when detection unit 130 starts detection of a touch, the captured image taken by imaging unit 110 when detection unit 130 started detecting the touch, may be read from the captured images temporarily stored in the buffer and the read captured image may continue to be displayed on display unit 120.

Thereafter, at Step 5 control unit 140 determines the identified area based on the position on the screen of display unit 120, at which detection unit 130 detected the touch.

FIG. 5 is a diagram showing one example of a touch operation performed on the screen of display unit 120, detected by detection unit 130 shown in FIG. 1.

For example, as shown in FIG. 5, when detection unit 130 detects a touching operation at point A on the screen of display unit 120 and detects that the touching operation is continuous as the object that is touching the screen moves from point A to point B (the object continues touching the screen of display unit 120 from point A to point B) and then loses detection of the touch at point B, control unit 140 determines the range from point A to point B as the identified area.

FIG. 6 is a diagram showing another example of a touch operation performed on the screen of display unit 120, detected by detection unit 130 shown in FIG. 1.

For example, as shown in FIG. 6, when detection unit 130 detects a touching operation at point C on the screen of display unit 120 and detects that the touching operation is continuous as the object that is touching the screen draws a circle from point C and returns to point C (the object continues touching the screen of display unit 120 from point C to point C), and then loses detection of the touch when the touch returns to point C, control unit 140 determines the range enclosed by the circle along which the continuous touch from point C was detected, as the identified area.

By determining the identified area in the above way, it is possible to select (designate) the desired information from the captured image being displayed on display unit 120.

Then, at Step 6 control unit 140 extracts information included in the determined identified area from the captured image being displayed on display unit 120.

Next, from among the information processing methods in information processing apparatus 100 shown in FIG. 1, the process of storing the extracted information and reading and displaying the information when a command to read the stored information is given, will be described.

FIG. 7 is a flow chart for explaining the process, in the information processing method in information processing apparatus 100 shown in FIG. 1, of storing extracted information and reading and displaying the information when a command to read the stored information is given.

First, at Step S11 control unit 140 determines whether or not information is extracted from the captured image being displayed on display unit 120.

When information has been extracted from the captured image being displayed on display unit 120, control unit 140 writes the extracted information into storage 160 at Step 12.

Thereafter, at Step 13 control unit 140 determines whether or not a command to read information stored in storage 160 is given. The method for this determination may be that the control unit determines that a command to load has been given based on reception of a predetermined input from the outside. For example, when a predetermined menu was selected from the menu displayed on display unit 120, control unit 140 may determine that a read command has been given.

When a command to read information stored in storage 160 is given, control unit 140 reads out information from storage 160 at Step 14.

Then, at Step 15 control unit 140 causes display unit 120 to display the information read out from storage 160. The method of this display may be done by starting up an application that can display information to display the information in the display portion of that application.

FIG. 8 is a diagram showing one example of a screen on which information is displayed in display unit 120 shown in FIG. 1. Herein, description will be made by giving an example where information “abc” has been read.

As shown in FIG. 8, on display unit 120 shown in FIG. 1, an image of tag paper 121 is displayed by a predetermined information display application, and information “abc” is displayed on tag paper 121.

Next, in the information processing method in information processing apparatus 100 shown in FIG. 1, a process of searching for related information using the extracted information as a search key will be described. Herein, description will be made by giving an example in which a search for related information relating to the subject information is performed using the extracted information as a search key, on an outside search site to which information processing apparatus 100 can connect.

FIG. 9 is a flow chart for explaining the process, in the information processing method in information processing apparatus 100 shown in FIG. 1, of searching for related information relating to the extracted information, by using the extracted information as a search key.

First, at Step 21 control unit 140 determines whether or not any information is extracted from the captured image being displayed on display unit 120.

When information has been extracted from the captured image being displayed on display unit 120, control unit 140 transmits the extracted information as a search key to the search site via communication unit 170 at Step 22. Herein, it is possible to provide a configuration in which the extracted information is displayed on display unit 120 while control unit 140 is adapted to transmit that information to the search site when receiving a predetermined input.

FIG. 10 is a diagram showing one screen example in which extracted information and a command key for sending the information to the search site are displayed on display unit 120 shown in FIG. 1. Herein, description will be made giving an example where information “abc” was extracted.

As shown in FIG. 10, the extracted information “abc” is displayed in search key input field 122 on display unit 120. Then, as search command key 123 displayed on display unit 120 is selected by the user, the information being displayed is transmitted as a search key.

Control unit 140 may also include a function (information determining function) of analyzing the extracted information to determine whether the information is image information or textual information. In this case, if control unit 140 determines that the extracted information is image information, the information is transmitted as a search image to the search site. On the other hand, when control unit 140 determines that the extracted information is textual information, the information is transmitted as a search key word to the search site. Further, not only simply determining whether the information is image information or textual information, the control unit may further include a function (detail determining function) of determining what the image is if the information is image information and what the text is if the information is textual information. If information processing apparatus 100 is not equipped with this detail determining function, the function may be provided for the equipment on the destination side.

Moreover, if control unit 140 has no information determining function of this kind, the control unit 140 may transmit the extracted information directly without analysis to the search site.

Thereafter, at Step 23 control unit 140 determines whether communication unit 170 has received the search result transmitted from the search site.

When communication unit 170 has received the search result transmitted from the search site, display unit 120 displays the result at Step 24.

FIG. 11 is a diagram showing one screen example in which the search result received by communication unit 170 shown in FIG. 1 is displayed on display unit 120.

As shown in FIG. 11, the search result received by communication unit 170 is displayed in a list view on display unit 120. For an additional search, add command key 124 is displayed on display unit 120. Thereafter, as add command key 124 that is displayed on display unit 120 is selected by the user, display unit 120 may display the captured image. Once the above-described prescribed operation is done, control unit 140 extracts information once again so that the extracted information may be additionally input (displayed) in search key input field 122 shown in FIG. 10 to be added to “abc”.

FIG. 12 is a diagram showing another exemplary embodiment of an information processing apparatus of the present invention.

As shown in FIG. 12, information processing apparatus 101 in this embodiment is equipped with control unit 141 instead of control unit 140 shown in FIG. 1, further including mode setter 180.

Imaging unit 110, display unit 120, detection unit 130, extraction unit 150, storage 160 and communication unit 170 are the same as those in the configuration shown in FIG. 1.

Mode setter 180 sets up either the imaging mode for performing an imaging process (storing the captured image as a still image or a movie) of the captured image displayed on display unit 120, or the identifying mode for performing the above-described extracting process of the extraction unit 150, as the operation mode of information processing apparatus 101. This setting may be done based on the content of input when a predetermined input is received from the outside. For example, a pane for selecting the imaging mode or the identifying mode may be displayed in the menu displayed on display unit 120, so that, based on user selection, one of them can be set up.

In addition to the functions of control unit 140 shown in FIG. 1, control unit 141 determines an operation detected by detection unit 130 as a predetermined operation when mode setter 180 has set up the identifying mode as the operation mode. In other words, for example, when detection unit 130 is a contact sensor, if detection unit 130 detects a touching operation, the control unit will regard the touching operation as a prescribed operation regardless of whether or not the touching object moves.

From among the information processing methods in information processing apparatus 101 shown in FIG. 12, the process up to extraction of information will be described hereinbelow.

Description herein will be made by giving an example where detection unit 130 is a contact sensor. That is, description will be made by giving an example where the operation to be detected by detection unit 130 is a “touch” in which the screen of display unit 120 is touched by an object.

FIG. 13 is a flow chart for explaining the process up to extraction of information, in the information processing method in information processing apparatus 101 shown in FIG. 12.

First, at Step 31 control unit 141 determines whether or not a command to start imaging is given. The method of this determination is the same as that explained using the flow chart shown in FIG. 4.

Once a command to start imaging is given, imaging unit 110 is activated so that the captured image taken by imaging unit 110 is displayed on display unit 120 at Step 32.

Then, at Step 33 control unit 141 determines whether or not the operation mode set in mode setter 180 is the identifying mode.

When the operation set in mode setter 180 is not the identifying mode, or is the imaging mode, a normal imaging process is performed at Step 34.

On the other hand, when the operation mode set in mode setter 180 is the identifying mode, detection unit 130 starts detecting a touch to the screen of display unit 120 at Step 35.

When detection unit 130 detects a touch, at Step 36 control unit 141 determines that the touch is a prescribed operation, and continues displaying the captured image taken at a predetermined timing, selected from among the captured images that have been taken by imaging unit 110, on display unit 120. At this time, as the user sees display unit 120, the image being displayed on display unit 120 is fixed like a still image, the same as described in the process at Step 4. The predetermined timing herein may be the time when detection unit 130 starts detection of a touch, or the time when control unit 141 determines that the moving distance, from the location that the touching object moves, exceeds the threshold. If the predetermined timing is assumed to be the time when detection unit 130 starts detection of a touch, the captured image taken by imaging unit 110 when detection unit 130 started detecting the touch, may be read from the captured images temporarily stored in the buffer and the read captured image may continue to be displayed on display unit 120, as described above.

Thereafter, at Step 37, control unit 141 determines the identified area based on the position on the screen of display unit 120, at which detection unit 130 detected the touch, in the same manner as described for the process at Step 5.

Then, at Step 38 control unit 141 extracts information included in the determined identified area from the captured image being displayed on display unit 120.

The methods of storing and displaying extracted information, and searching based on the extracted information are the same as those explained with the flow charts shown in FIGS. 7 and 9.

Other than the above, the extracted information may be copied as the predetermined position and the input to another application.

In this way, when a predetermined operation is input with a captured image displayed, the captured image being displayed is fixed to the captured image taken at a certain timing. Accordingly, it is possible to easily select desired information in the image being displayed.

The process which each component provided for the above-described information processing apparatus 100, 101 performs an operation may be realized by a logical circuit prepared depending on purposes. Alternatively, a computer program (which will be referred to hereinbelow as program) describing the sequence of the processing contents may be recorded on a recording medium that can be read by information processing apparatus 100, 101, so that the program recorded on this recording medium can be loaded into information processing apparatus 100, 101 and executed thereby. Examples of the recording medium that can be read by information processing apparatus 100, 101 include removable recording media such as floppy (registered trademark) disks, magneto optical disks, DVDs, CDs, etc., and HDDs and memories such as ROM, RAM and the like incorporated in information processing apparatus 100, 101. The program recorded on the recording medium is loaded by control unit 100 and 101 provided for information processing apparatus 100 and 101 respectively, and the same process described above is carried out by control units 140 and 141. Here, control units 140 and 141 operate as a computer for executing the program loaded from the recording medium with the program recorded thereon.

Although the present invention has been explained with reference to the exemplary embodiments, the present invention should not be limited to the above exemplary embodiments. Various modifications that can be understood by those skilled in the art may be made to the structures and details of the present invention within the scope of the present invention.

This application claims priority based on Japanese Patent Application No. 2011-275609, filed on Dec. 16, 2011, and should incorporate all the disclosure thereof herein.

1. An information processing apparatus comprising:
an imaging unit;
a display unit that displays captured images taken by the imaging unit;
a detection unit that detects an operation performed on a screen of the display unit;
a control unit that continues displaying a captured image taken at a predetermined timing, of the captured images, on the display unit when the operation detected by the detection unit is a predetermined operation.

2. The information processing apparatus according to claim 1, wherein when the moving distance from the position touched by the touching operation detected by the detection unit on the screen exceeds a predetermined threshold, the control unit determines that the operation is the predetermined operation.

3. The information processing apparatus according to claim 2, further comprising
an extraction unit that extracts the information displayed in an identified area corresponding to the position on the screen at which the operation was detected by the detection unit, from the captured image being displayed on the display unit.

4. The information processing apparatus according to claim 1, further comprising
an extraction unit that extracts the information displayed in an identified area corresponding to the position on the screen at which the operation was detected by the detection unit, from the captured image being displayed on the display unit; and
a mode setter that sets up either the imaging mode for performing an imaging process of the captured image displayed on the display unit, or the identifying mode for performing the extracting process of the extraction unit as an operation mode of the information processing apparatus,
wherein the control unit determines an operation detected by the detection unit as the predetermined operation when the mode setter has set up the identifying mode as the operation mode.

5. The information processing apparatus according to claim 3, wherein the control unit, using the information extracted by the extraction unit as a search key, searches for information that relates to the extracted information.

6. The information processing apparatus according to claim 5, wherein the control unit, using the search key, causes a communication device communicable with the information processing apparatus to search for information that relates to the extracted information, and acquires the search result.

7. The information processing apparatus according to claim 3, further comprising
a storage that allows information to be written therein and to be read therefrom, and,
wherein the control unit writes the information extracted by the extraction unit into the storage.

8. The information processing apparatus according to claim 7, wherein the control unit reads information written in the storage, and the display unit displays the information read by the control unit.

9. The information processing apparatus according to claim 1, wherein the detection unit is a contact sensor or a proximity sensor.

10. An information processing method of processing information displayed on a display unit, comprising the steps of:
imaging;
displaying captured images taken by the imaging, on the display unit;
detecting an operation performed on a screen of the display unit;
determining whether or not the detected operation is a predetermined operation; and
continuing display of a captured image taken at a predetermined timing, selected from among the captured images, on the display unit when the detected operation is a predetermined operation.

11. A recording medium storing a program for causing an apparatus including a display unit to execute a process comprising:
a step of imaging;
a step of displaying captured images taken by the imaging, on the display unit;
a step of detecting an operation performed on a screen of the display unit;
a step of determining whether or not the detected operation is a predetermined operation; and
a step of continuing display of a captured image taken at a predetermined timing, selected from among the captured images, on the display unit when the detected operation is a predetermined operation.
